(19) United States
(12) Patent Application Publication
(10) Pub. No.: US 2012/0081509 A1
(43) Pub. Date: Apr. 5, 2012

(54) OPTICAL INSTRUMENT SYSTEM AND METHOD

(76) Inventors: Georg Kormann, Zweibruecken (DE); Nico Correns, Weimar (DE); Söldner Dietrich, Jena (DE)

(21) Appl. No.: 13/240,015

(22) Filed: Sep. 22, 2011

(30) Foreign Application Priority Data
Sep. 27, 2010 (DE) 10 2010 041 490.5

(51) Int. Cl. H04N 5/225

(52) U.S. Cl. 348/36; 348/E07.085

(57) ABSTRACT

An optical instrument system produces and analyzes images of the surrounding area. The system includes an overview lens with a symmetry axis which produces a first circular image of the surrounding area. The system also includes an observation lens which captures a second image of the surrounding area, and which is pivotal over 360° about the symmetry axis, and which is spaced apart a predetermined distance from the overview lens. The observation lens has an optical axis which is perpendicularly to the symmetry axis. The system includes an imaging optics system which reproduces the images of the surrounding area as overview image and observation image on a surface detector. A control unit controls the observation lens. An evaluation unit analyzes the images, and, for selected objects, which are detected both in the overview image and also in the observation image, determines the distance to said objects.

### FIELD OF THE INVENTION

The present disclosure relates an optical instrument for observation of the surrounding area, particularly of moving objects, such as vehicles, and a method for using such an optical instrument.

### BACKGROUND OF THE INVENTION

In the state of the art, various methods and arrangements are known for observing an area over an angle of 360° with an optical instrument. Thus, in EP 1375253 B1, a method for monitoring the interior or exterior of a vehicle with an omniview camera is described. The omniview camera is a catadioptric system, which includes a first conventional CCD camera, and a spherically or paraboloid-shaped convex mirror, which is spaced apart from the camera. In a central area, an image of the camera is reproduced due to the mirror shape, but this can be electronically removed. A second camera is used to magnify portions, selected by an interpretation device, of areas captured by the first camera.

In DE 10 2005 006 754 A1, a spherical mirror and a camera for all-round acquisition are used; in the central region, a second mirror system with a planar mirror is provided for imaging a second space region of interest. In the central region, a detail of the region which is imaged by the all-round camera is magnified. The section which is reproduced in the central region can also be selected automatically with the help of the imaging of the all-round camera, and the additional mirror system can be set based on this. With the help of an image processing system, distortions can be removed from the image of the all-round camera, but the image processing also includes means for performing a triangulation procedure to determine the position of objects which are present in both images. This can be used particularly in cases where the camera system should recognize objects, particularly pedestrians in the outside area of a motor vehicle.

Another optical system for all-round space monitoring is described in DE 10 2004 047 932 A1. This system also includes two mirror optics systems, one of which includes a mirror with convex curvature for the all-round imaging over a 360° angle, and the other mirror optical system includes a planar mirror for reproduction of detail. This planar mirror is movable, and, in addition, a zoom function can be implemented with the help of a translation movement relative to the object.

Another image capture system, including a camera and two mirror systems with a curved and a planar mirror is described in DE 10 2004 056 349 A1. Here, by means of the curved mirror, a near field is captured with a viewing angle of approximately 180°, and the far field is captured with the planar mirror or directly with the camera. The system is intended for use in motor vehicles.

In GB 2 368 221 A, a camera is described which presents both the all-round vision and also a direct imaging mode. The camera can also be operated simultaneously in both modes. For the implementation, as in the previously mentioned publications, an optics system that is catadioptric and consequently of relatively complex design can be used.

In WO 03/026272 A2, besides the use of mirror-based systems, imaging optics systems are also described which consist essentially of a single lens that is partially covered with a reflective coating. A portion of the lens is designed so that it reproduces an overview image, and, in the central region, another portion of the lens, which otherwise would represent a blind spot or reproduce the camera optics itself, is designed so that it reproduces a magnification of a partial region of the surrounding area on a detector. The design of the lens is very complicated, and the system is not suitable for a precise position determination, because of the small separations of the correspondingly imaging lens regions.

An entirely different solution is described in DE 29 26 731 C2. In this system several lenses of equal focal lengths are arranged on a circle, so that, in this manner, a corresponding imaging of the panorama can occur, assuming that there are corresponding continuing light paths.

Mirrors can be completely omitted from periscope like systems, as described, for example, in the 5th volume “Telescopes and distance measuring device [in German” by A. König, published by Verlag Julius Springer, 1923, on pages 63-70. They are systems with a so-called panorama view lens, which reproduces the surrounding area over an angle of 360°, and an observation lens which reproduces a detail area of the surrounding area. An observer perceives the image of the overview lens as a ring with an empty spot remaining at its center, which is however filled with the observation image of the observation lens. The two lenses do not influence each other mutually. No utilization for position determination or distance determination is indicated in this connection.

It is desired to provide an optical instrument for optical monitoring of space, whose design is as simple and robust as possible, which can be manufactured cost effectively, and which is particularly suitable for distance measurement, and also suitable for automatic control of agricultural machines, as well as to provide a method for monitoring space, in which said optical instrument can be used advantageously.

### SUMMARY

According to an aspect of the present disclosure, an optical instrument system observes the surrounding area. The instrument includes a circular overview lens arranged around a symmetry axis. The optical instrument also includes an observation lens which captures a second surrounding area, and which is arranged on the symmetry axis at a predetermined distance from the overview lens. The observation lens is pivotal about the symmetry axis over an angular range of at least 360°. The optical axis of the observation lens extends perpendicularly or at least approximately perpendicularly to the symmetry axis of the overview lens. It is preferred that the observation lens can be pivoted through a full circle, because in that case the entire surrounding area can be observed under identical conditions, and the observation lens can be aimed on a point of interest in a centered manner in each case. However, the formulation “of up to 360° inclusive” also includes smaller angular ranges that do not cover the full circle.

The optical instrument system also includes at least one surface detector and an imaging optics system, which simultaneously reproduces the first surrounding area captured by the overview lens and the second surrounding area captured by the observation lens as an overview image or observation image on at least one surface detector. Furthermore, the system also includes a control unit which controls the observation lens. For this purpose, it can control, for example, in each case at least one actuator for the adjustment of the focal length of the observation lens and/or of the angle of the observation lens, about the symmetry axis of the overview lens. However, the control unit can also perform more complex tasks, such as, the control and monitoring of the steering and/or driving of the vehicle. Finally, the system also includes an evaluation unit which analyzes the image, and which determines, for selected objects which were detected both in the overview image and also in the observation image, the distance from those objects, and transmits it, together with the position of the object, to the control unit for further processing. The evaluation unit and the control unit can also be integrated together in a single control unit.

The overview lens captures an image of a circular surrounding area which extends 360° about the symmetry axis. At the same time, the observation lens captures an image of a second surrounding area, which is a section or portion of the first surrounding area. The selection of the objects is carried out on the basis of the overview image. After the observation lens has been adjusted to the selected object, the absolute distance to the object can be determined using the different viewing angles of the overview lens and the observation lens on the object, where, in addition, the size of the object and the separation between the object, captured in each case, can be taken into account. The greater the distance between the lenses along the symmetry axis is, the better the stereoscopic effect, and thus the spatial resolution.

If the image analysis shows that the distance has fallen, for example, below a certain critical limit, the control unit can initiate appropriate additional steps. If the optical instrument and the control unit are located, for example, in a vehicle, particularly an agricultural machine, then the control unit can stop the vehicle, reduce its speed, or initiate an avoidance maneuver, to prevent, in general, a collision with the selected object. The optical instrument can also be used for the acquisition of relative positions of several vehicles, and optionally also for the automatic steering of one or more of the vehicles, or for steering the vehicle along a predetermined path.

Usually, but not necessarily, the symmetry axis is oriented exactly vertically in the space, so that the optical axis of the observation lens extends horizontally or at a slight downward inclination to detect objects on the ground. The optical instrument, if it is attached to a vehicle, can be rigidly attached to said vehicle, or it can advantageously always be oriented vertically using an alignment means, as soon as deviations from this orientation occur. This can occur, for example, by means of passive alignment means, such as, a pendulum, or by means of an active alignment means, such as, an actuator coupled to an inclination sensor. The attachment of the optical instruments occurs preferably at a place of the vehicle that is sufficiently high to provide a panorama view.

In a preferred embodiment, the evaluation unit analyzes in a temporally sequential manner overview images recorded by the surface detector with regard to objects which move relative to the optical instrument. If such a moving object, particularly one that is becoming larger, is detected, the evaluation unit transmits the position determined on the basis of the sequence of overview images to the control unit. If the optical instrument is provided with a surface detector, which enables a determination of the distance by means of travel time measurements, then an approximate distance determination can also occur by means of the travel time evaluations of the surface detector. However, for a precise distance determination, the control unit aims the observation lens on the moving selected object, so that, as described above, a distance measurement can be carried out.

If image processing detects several objects that move relative to the optical instrument, particularly if they become larger, then all these objects are selected, and the distance to all these objects must be determined successively. Objects that have already been measured are thus no longer located within the second surrounding area which the observation lens is currently acquiring. However, to be able to continue to monitor these objects with regard to impending collisions, these objects are analyzed using the temporally received sequences of overview images which are recorded after the distance determination. Using the changes with regard to length and/or size or the angular speed, it is then also possible to determine changes in the distance within a certain accuracy range. If one uses a surface detector which allows a distance measurement, the monitoring of these objects is simplified slightly.

In a particularly preferred embodiment of the optical system, the overview lens comprises a panoramic lens reproducing an angle of 360°. Preferably the panoramic lens has a cylindrical, conical or spherical lateral surface, a spherically inner surface covered with a reflective coating, and a planar or conical front surface. In this case, the image is ring shaped, where the inner region of the ring remains clear. The surface detector may be for example, conventional a CCD or CMOS chip. In this inner region of the ring, the image of the observation object is reproduced. Thus, the two objects do not influence each other mutually. Their images can be used completely, because no shadowing effects occur. A spherical lens can also be used instead of a panoramic lens.

To increase the accuracy of the stereoscopic measurement or to vary it, it is advantageous if the predetermined separation of the observation lens can be adjusted variably along the symmetry axis. This can be implemented, for example, via the control unit, which, for this purpose, controls an actuator for the adjustment of the separation between the observation lens and the overview lens. Here, one must ensure that the change in adjustment is taken into account in the calculation of the distance; the separation is incorporated directly as a parameter in the image processing.

The overview lens and/or observation lens can also be designed as Vario lenses with varying focal length. This allows an even more flexible adaptation to different sizes and distances of objects. The magnification of the observation lens is preferably greater than that of the overview lens, so that the detail on which the observation lens is aimed can be represented with higher resolution. In addition, it is also possible to design one of the two lenses or both lenses so that the magnifications are different or vary in two mutually perpendicular directions. To be able to reproduce distances that are farther away, when monitoring for collision prevention, and at the same time carry out a distance determination, it is perfectly reasonable to select a higher magnification for the overview lens in the horizontal direction than in the vertical direction, particularly if the optical instrument is attached at a certain height. Objects that are captured more in the vertical direction are already closer to the optical instrument and consequently also measured more accurately, at lower magnification. While these different magnifications can be taken into account in image processing without problem, a prior removal of distortions of the image is expedient, for the representation on a monitor for an observer.

To keep the processing expense as low as possible, it is advantageous to record overview images less frequently than the observation images. Because the distance to the selected objects is determined more accurately by means of the observation lens than with the overview lens, the higher scanning frequency is advantageous, while the overview lens can be used for the approximate determination of the distance, if appropriate means are provided for this purpose, for example, a spatially resolving surface detector.

While in a simple design, only one surface detector is used, the use of several surface detectors is also possible, for example, if a point distance measuring device, such as, a laser distance measuring device, is integrated additionally in the optical instrument. The measurement of the latter device can be processed on another sensor. Suitable sensors are particularly CMOS sensors, because they can also be read partially with great frequency, which facilitates particularly the reading out with different scanning frequencies.

Instead of a purely two-dimensional surface detector, it is also possible to use spatially resolving surface detectors, that is with sensors in the individual positions of the matrix, which are provided with means for travel time measurement. Suitable are, for example, photonic mixer sensors (PMD). The active illumination source required for the travel time measurement, which generally transmits infrared light, is arranged here either in the shape of a ring around the panoramic lens, or in the shape of a circle around the outer lens of the observation lens. For the distance determination, the observation lens is then not necessarily required, that is it does not necessarily need to record a detail of the overview image. For a more accurate distance determination, the observation lens must however be aimed again on the object.

When using spatially resolving sensors in the surface detector, the overview image and observation image can also be reproduced simultaneously on a matrix of the surface detector; alternatively, an alternating reproduction of the images on the matrix of the detector is also possible, for example, if only one of the lenses has an active illumination for the distance determination. The use of several spatially resolving sensors and/or several two-dimensionally working sensors is possible, and it is also conceivable to use the combination of spatially resolving and purely two-dimensionally reproducing sensors. The overview image and observation image can then be reproduced in each case on different surface detectors that are optimized for the images.

This system performs a method for optical monitoring of the space in the surrounding area of moving vehicles. The method uses particularly the above-described optical instrument, and in which, on the one hand, a first surrounding area is captured continuously with an overview lens, in a circular manner about a symmetry axis of the overview lens, and, on the other hand, a second surrounding area is captured with an observation lens, where the optical axis of the observation lens extends perpendicularly to the symmetry axis of the overview lens, and the observation lens is located at a predetermined separation along the symmetry axis with respect to the overview lens. Via imaging optics, the first surrounding area is reproduced as overview image, and the second surrounding area as observation image simultaneously on at least one surface detector. An evaluation unit performs an image interpretation, and determines for selected objects, which are detected both in the overview image and also in the observation image, the distance to these objects, and it transmits the distance to a control unit for further exploitation. Depending on the distance determined, the control unit can give instructions to the operator of the vehicle, for example, to the effect that the vehicle is approaching an object, or an object is approaching the vehicle, and that a collision is imminent if the direction of movement is maintained. However, in automatic control of the vehicles, the control unit can itself initiate appropriate measures to prevent a collision, for example, to steer around an obstacle, stop, etc. The observation lens and the overview lens are here spatially uncoupled from each other, and constitute independently controllable units, and the light paths are combined only by means of the imaging optics. In this manner, one achieves a high flexibility in comparison to a lens produced using a lens that is manufactured as a single piece; the problem of the self imaging camera system or surface detector can also be prevented by means of an appropriate design of the overview lens.

In a preferred embodiment of the invention, the surface detector records temporally sequential overview images. The latter are then analyzed by image processing by the evaluation unit with regard to objects moving with respect to the vehicle. If such a moving object, particularly one that increases in size, is detected, the evaluation unit of the control unit transmits the approximate position determined on the basis of the sequence of overview images. The control unit selects this object then, so that said object then becomes one of the selected objects. Subsequently, the observation lens is aimed on the moving objects, and thereafter the evaluation unit with image processing again determines the distance to this object. Here, one exploits the fact that the overview lens and the observation lens observe the selected object from slightly different viewing angles, which allows a stereoscopic analysis, for example, with the help of triangulation methods. The overview lens and the observation lens can here be arranged, in comparison to the mirror systems known in the state of the art, at a greater separation from each other, which increases the accuracy of the stereoscopic measurement.

If, for a selected object, the distance has already been determined once by means of the stereoscopic measurement, then an additional monitoring of the distance using the overview images can be carried out, without using the observation lens. This occurs due to the fact that the evaluation unit analyzes the change in the size and/or position of the selected object between two overview images recorded sequentially over time. The observation lens in the meantime can be aimed on another object. An additional determination of the distance to the selected objects can also be carried out complementarily by point laser measurement. Equivalently, other methods can also be used for the distance measurement, based, for example, on ultrasound or radar. In addition, a spatially resolving surface detector can also be used, which determines the distances with the help of long-term measurements of electromagnetic waves.

The above described optical instruments can also be used in particular to carry out a method with the above described process steps, in order to prevent automatically collisions of vehicles used in agriculture, or to steer a vehicle relative to at least one other vehicle or along a path.

### BRIEF DESCRIPTION OF THE DRAWINGS

FIG. 1 is a schematic diagram of an optical instrument control system;

FIG. 2 is a longitudinal cross section diagram of an optical instrument for monitoring the surrounding area;

FIG. 3 is a schematic representation of image areas produced by the optical instrument of FIG. 2; and

FIG. 4 is a schematic representation of an image reproduced on a surface detector.

### DETAILED DESCRIPTION OF THE DRAWINGS

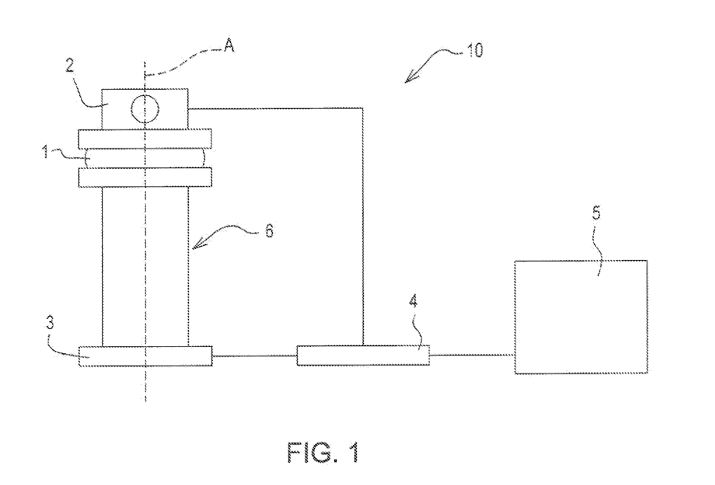

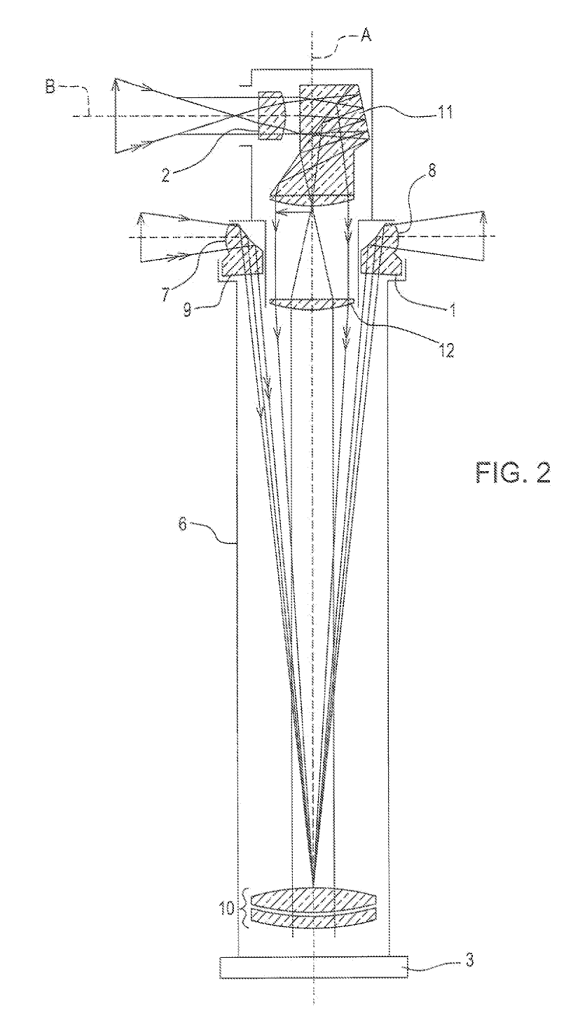

Referring to FIGS. 1 and 2, an optical instrument system 10 observes the surrounding area preferably in an automated manner, and can be used for collision prevention and/or for automatic steering of a vehicle which moves parallel to the side of another vehicle, for example, during load transfer processes of harvest material, or when simultaneously working a field with two vehicles. The optical instrument system 10 includes an overview lens, preferably a panoramic lens 1 which is symmetrical about a symmetry axis A. The symmetry axis A corresponds to the rotation axis which defines the rotation symmetry for arbitrarily small angles. It is located in the plane of the drawing and extends perpendicularly with respect to the latter. The overview lens captures a first image of the surrounding area in a circular manner about the symmetry axis A. The optical instrument system also includes an observation lens 2 which captures a second image of the surrounding area. The observation lens 2 is arranged on the symmetry axis A at a predetermined distance from the overview lens. Its optical axis B is perpendicular with respect to the symmetry axis A of the overview lens, and it is pivotable by 360° about the symmetry axis A. Instead of a panoramic lens 1, a spherically distorted lens can also be used.

The optical instrument system also includes a surface detector 3 and imaging optics which reproduce simultaneously the surrounding areas captured by the overview lens and the observation lens 2 as overview image and observation image, respectively, on the surface detector 3. The system also includes a control unit 4 which controls the observation lens 2, and an evaluation unit 5 which analyzes the images, and determines, for selected objects which are detected both in the overview image and also in the observation image, the distance to these objects, and transmits distance signals to the control unit 4 for further processing. The control unit 4 and the evaluation unit 5 can also be constructed as a single unit which has both interpretation and also control functions.

The images recorded by the surface detector 3 can be displayed on a monitor (not shown) so that an observer can perform an interpretation with regard to objects of interest. Objects of interest are, for example, in the context of collision prevention, objects which move relative to the optical system attached to a vehicle, and increase in size relative to a temporal sequence of overview images. Such objects are then selected, and the operator can then aim the observation lens 2 on such a selected object, the distance can be determined automatically, where the separation between the two objects along the symmetry axis A is used as an aid, that is, the stereoscopic effect resulting from the different viewing angles of the overview lens and observation lens 2 on the object. Under some circumstances, it can also be advantageous to design the separation to be variable so that, for example, the separation can be variable depending on object size.

However, monitoring is preferably carried out automatically. For this purpose, the surface detector 3 records sequentially over time overview images. The evaluation unit 5 analyzes these images with the help of image processing, with regard to objects which move relative to the optical instrument. If such a moving object, particularly one that increases in size (that is comes closer to the optical instrument) is detected, the evaluation unit 5 transmits the position determined from the analysis of the sequence of overview images to the control unit 4, so that the control unit 4 can select this object, and the observation lens 2 can be aimed at the moving object, particularly for controlling an actuator used to rotate the observation lens 2 about the symmetry axis A, a process which is not represented here. The evaluation unit 5 then determines, as described above, the distance to this object.

If several such objects are found and selected, the determination of the distance is carried out successively for all the objects one after the other. An additional monitoring of the distance to the selected lenses occurs exclusively on the basis of the overview images. For this purpose, the evaluation unit 5 with its imaging unit analyzes the change in size and/or position in overview images recorded sequentially over time. Using the changes, the distance to the respective selected object can be determined and monitored, with reduced accuracy as a function of the magnification of the overview image, provided no surface detector with spatially resolving sensor elements is used. Complementarily, an additional determination of the distance to the selected objects can also be carried out by point laser measurement, but this increases the cost.

Referring now to FIG. 2 the optical portion of the optical instrument system defines a plurality of light paths. The panoramic lens 1 is located at the upper end of an imaging tube 6. The panoramic lens 1 creates a first circular image of the surrounding area over an angle of 360°. The panoramic lens 1 has a spherical lateral surface 7. The lateral surface can, however, also be designed in the shape of a cylinder or cone. The light coming from an object travels through the lateral surface 7 into the lens, and it is reflected by a spherical inner surface 8 which is covered with a reflective coating in the direction of the imaging tube 6. At a planar front surface 9, the light then enters into the imaging tube 6. The front surface 9 can alternatively also be designed in the shape of a cone. At the other end of the imaging tube 6, a lens pair 10 is located, which is part of the imaging optics, and which guides the light to the surface detector 3.

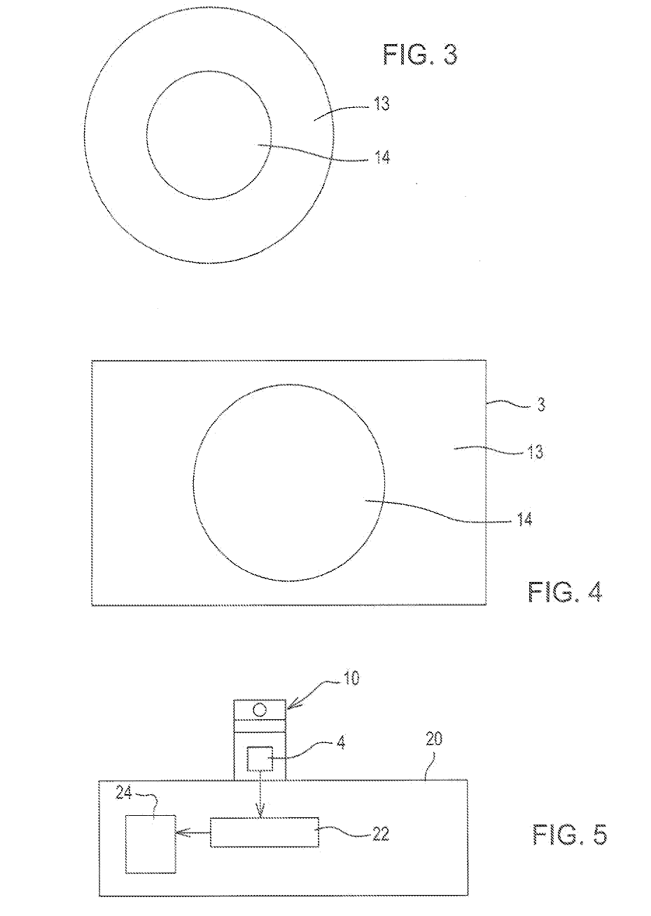

Light arriving from an object (represented as also in the case of the panoramic lens 1 by a vertical arrow) which enters into the observation lens 2, is also guided via a prism-lens combination 11 and a lens 12 into the imaging tube 6, and it is also directed via the lens pair 10 onto the surface detector 3. Referring now to FIG. 3, this produces an overview image in an overview image area 13 and an observation image in an observation image area 14. Due to the beam guidance, no mutual shadowing effects of the lenses occur, and the two lenses do not influence each other mutually. The image illustrated in FIG. 3 is also produced on the surface detector 3, as shown, not to scale, in FIG. 4. The marginal areas of the overview image area to the right and left are darkened as a rule. However, the overview image is reproduced completely on the surface detector 3. If the image interpretation is performed automatically with the help of an image processing procedure implemented in the evaluation unit 5, the prisms of the prism-lens combination 11 can also be replaced by a mirror or a simple 45° prism, because rotation and twisting of the image is not necessary for image processing. Since image interpretation requires several special processing routines adapted to the optical instrument, it is advantageous to use special circuit structures for rapid processing are used, for example, field programmable gate arrays (FPGA) and digital signal processes (DSP). As sensor array of the surface detector, a CCD chip can be used, for example; however, it is particularly advantageous to use a CMOS chip, because it allows a partial reading of the image elements with great frequency. In this manner it is possible, for example, that the evaluation unit records five overview images at a temporally lower frequency than the observation images. As a rule, the observation image is read more frequently, because, with the help of this image, a precise distance determination can be carried out. The scanning frequency for reading the overview image can be lower, because the latter is required only for the approximate distance determination or for monitoring the distance to already selected and measured objects. The relative movement with respect to the sensor is determined by means of the angular speed. The scanning frequencies can here also be predetermined or modified as a function of external parameters, for example, as a function of the differential speed with respect to the vehicle.

Different variants are possible for the design of the surface detector 3. In the simplest case, a simple array made of surface resolving sensors is used, on which the two images are reproduced. However, several sensors can also be used, which can be coupled, for example, so that each one of the sensors displays a portion of the entire image shown in FIG. 4. However, the overview image and observation image can also be reproduced on different sensors. The sensors of the surface detector 3, which resolve only in the plane, can also be used coupled with a point distance measuring device through the observation lens, for example, a laser distance measuring device.

However, instead of a simple surface detector 3 which resolves only in the plane, spatially resolving surface detectors 3 can also be used. In principle, they are also surface detectors 3; however, for the registration of the intensity of received signals, they also have available a means for calculating the distance between the individual elements of the matrix of the detector and of the surface of an object.

To determine the distance, the object can be illuminated with modulated light, for example, in the near infrared range (NIR) or in the visible range (VIS), and the distance determination is carried out by measuring travel time differences. The light signal received by the sensor element is demodulated by the sensor element, and correlated with a reference signal. From the phase shift, the depth information can be determined with a precision of several meters. This type of sensors is also called photonic mixer sensors (PMD), and it can also be used with the optical instruments described here. In this case, an active illumination source is required, which transmits the corresponding modulated light. This source can be arranged, for example, in the shape of a ring about the lens 1, and/or in the shape of a circle about the observation lens 2.

Moreover, the optical instrument can be designed so that the predetermined distance from the observation lens 2 to the overview lens along the symmetry axis A can be adjusted variably, for example, by an actuator (not shown) controlled via the control unit 4. The overview lens and/or observation lens 2 can also be designed as Vario lenses with variable focal length, so that zooming is possible, for example, by means of an actuator (not shown) controlled by the control unit 4. This must be taken into consideration accordingly in the image interpretation. As a rule, the magnification of the observation lens 2 is greater here than that of the overview lens, because a detail should be observed with the observation lens 2. This must also be taken into account appropriately, for example, if the separation of the observation lens 2 along the symmetry axis A can be adjusted variably.

In addition, it is possible to design both the overview lens and also the observation lens 2 so that the magnifications of the objectives are different in two mutually perpendicularly extending directions. For collision monitoring, it is possible, for example, to design the panoramic lens so that the horizontal region is reproduced with magnification compared to the region located above or below, because this increases the accuracy, and, as a rule, there should be no objects directly above the vehicle or beneath the vehicle, if the collision monitoring is working correctly. For an observer, distortions can then be removed from the recorded image appropriately; in the case of automated monitoring, the image processing can take into this distortion removal account, using the lens data itself.

If the optical instrument operates at least one surface detector which comprises the spatially resolving sensor elements, then the observation lens 2 for monitoring does not necessarily have to see a partial image of the overview lens, because the distance determination can then also be carried out using only the overview image. It is only when an object approaches up to a distance below a threshold value that, for example, the distance can be determined with greater accuracy using the observation lens 2. The subsequent monitoring can be carried out again with the overview lens alone, where the distance determination in comparison to the previously described method for surface detectors without spatially dissolving sensor elements, which is based on the determination of the angular speeds, is simplified here.

A combination of spatially resolving surface detectors with conventional surface detectors is also conceivable, for example, if the overview image is reproduced on a spatially resolving surface detector, and the observation image on a high resolution surface detector which registers only the intensities. The use of additional illumination sources which allow the operation of collision monitoring even at night is conceivable. Here, one must make sure that the illumination light does not lead directly to mutual interference of the light in the lenses. This also applies to the active illumination sources which are used in combination with the spatially resolving surface detectors. In addition, one must ensure that no influence of illumination units on different vehicles, or in the surrounding area, on the optical instrument occurs.

Referring now to FIG. 5, the optical instrument system 10 is mounted on a vehicle 20, such as an agricultural vehicle. The vehicle 20 includes a steering control unit 22 which is connected to an output of the control unit 4 of the optical instrument system 10. The steering control unit 22 controls the vehicle steering system 24 and thereby automatically guides the vehicle in response to signals from the control unit 4.

The above described optical instrument system is particularly suited for use in automatic collision prevention in vehicles used in agriculture. These machines move only at low speeds, so that automatic steering is also possible. The optical instrument which is applied to a vehicle used in agriculture can also be used for detecting shapes or edges in the field, for example, cutting edges, driving corridors, swaths, rows of trees, or furrows, to steer the vehicle in an automated manner on a desired path. it is also possible to use attached apparatuses or front loaders for the acquisition of the relative spatial position.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected.

It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. An optical instrument system for observing a surrounding area, comprising:
an overview lens which captures a first circular image of the surrounding area about a symmetry axis;
an observation lens which captures a second image of the surrounding area, and which is pivotable about the symmetry axis over an angular range of at least 360°, the observation lens being spaced apart a predetermined distance from the overview lens, and having an optical axis of which is oriented perpendicularly to the symmetry axis;
a surface detector;
a control unit for controlling the observation lens;
an imaging optics system which transmits the first and the second images as an overview image and an observation image to the surface detector; and
an evaluation unit which analyzes the images, and which, for selected objects which are detected both in the overview image and also in the observation image, determines, as a function of a separation between the overview lens and the observation lens, a distance to these objects, and transmits a distance signal to the control unit for further processing.

2. The optical instrument system of claim 1, wherein:
the evaluation unit analyzes overview images, recorded sequentially over time by the surface detector of objects which move relative to the optical instrument, and, if such a moving object which increases in size, is detected, transmits a position determined as a function the sequence of overview images to the control unit; and
the control unit aims the observation lens at the moving object.

3. The optical instrument system of claim 1, wherein:
the evaluation unit analyzes, for the selected objects, after the determination of the distance, a change in size and/or position in overview images recorded sequentially over time, and determines the distance as a function of the changes.

4. The optical instrument system of claim 1, wherein:
the overview lens comprises a panoramic lens with a field of view which extends over an angle of at least 360° and which has a cylindrical, conical or spherical lateral surface, and which has a spherical inner surface which is covered with a reflective coating, and which has a planar or conical front surface.

5. The optical instrument system of claim 1, wherein:
an output of the optical instrument system control unit is connected to a steering control unit of an agricultural vehicle, the steering control unit automatically guiding the vehicle in response to signals from the optical instrument system control unit.

6. A method for optical monitoring of an area surrounding a unit, the method including the following steps:
with an overview lens, capturing a first circular image of the surrounding area about a symmetry axis of the overview lens;
with an observation lens, capturing a second image of the surrounding area, the observation lens having an optical axis which perpendicularly to the symmetry axis, and the observation lens being spaced apart a distance along the symmetry axis from the overview lens;
via an imaging optics system, transmitting the first image as overview image, and transmitting the second image as observation image, simultaneously on to a surface detector; and
with an evaluation unit, analyzing the images, and, for selected objects which are detected both in the overview image and also in the observation image, determining the distance to these objects as a function of the separation between the overview lens and the observation lens, and transmitting a distance signal to a control unit for further processing.

7. The method of claim 6, further comprising:
with the surface detector, recording overview images sequentially over time;
with the evaluation unit, analyzing the images with respect to objects which are moving relative to the unit; and
if such a moving object is detected which has an image which increases in size, the evaluation unit transmitting a position determined as a function of the sequence of overview images to the control unit; and
the control unit selecting the moving object, and aiming the observation lens is aimed at the moving object.

8. The method according to claim 7, wherein:
for the selected objects, after the determination of the distance, monitoring the distance as a function of the overview images, and the evaluation unit analyzing changes in size and/or position between overview images recorded sequentially over time.

9. An agricultural vehicle comprising:
an optical instrument system for observing a surrounding area, the system having an overview lens which captures a first circular image of the surrounding area about a symmetry axis, an observation lens which captures a second image of the surrounding area, and which is pivotable about the symmetry axis over an angular range of at least 360°, the observation lens being spaced apart a predetermined distance from the overview lens, and having an optical axis of which is oriented perpendicularly to the symmetry axis, a surface detector, a control unit for controlling the observation lens, an imaging optics system which transmits the first and the second images as an overview image and an observation image to the surface detector, and an evaluation unit which analyzes the images, and which, for selected objects which are detected both in the overview image and also in the observation image, determines, as a function of a separation between the overview lens and the observation lens, a distance to these objects, and transmits a distance signal to the control unit; and
an automated steering control unit which is connected to an output of the optical instrument system control unit, and which automatically guides the vehicle in response to signals from the optical instrument system control unit.
